(19) United States
(12) Patent Application Publication
(10) Pub. No.: US 2012/0061627 A1
(43) Pub. Date: Mar. 15, 2012

(54) FLUORESCENT NANOPARTICLES, METHOD FOR PREPARING SAME, AND APPLICATION THEREOF IN BIOLOGICAL MARKING

(76) Inventors: Peter Reiss, Saint-Egreve (FR); Toufic Jean Daou, Mulhouse (FR); Isabelle Texier-Nogues, Grenoble (FR); Liang Li, Saint-Martin d'Heres (FR)

(21) Appl. No.: 13/127,460

(22) PCT Filed: Nov. 3, 2009
(86) PCT No.: PCT/EP2009/064558

§ 371 Date: Nov. 28, 2011

(30) Foreign Application Priority Data
Nov. 4, 2008 (FR) 0857497

(51) Int. Cl. H01B 1/00; C01G 15/00; B82B 3/00; B82B 1/00

(52) U.S. Cl. 252/519.14; 423/511; 977/896; 977/824

(57) ABSTRACT

A method for preparing nanocrystals is disclosed. According to one aspect, the noncrystals include a semiconductor ternary compound consisting of the elements A, B and C. According to another aspect, the nanocrystals include a semiconductor of formula ABC₂ optionally coated with a shell, the external portion of which includes a semiconductor of formula ZnS₁₋ₓFₓ, with A representing a metal or metalloid in the oxidation state +I, B representing a metal or metalloid in the oxidation state +III, C representing an element in the oxidation state −II, F representing an element in the oxidation state −II and x being a decimal number such that 0≦x<1. The disclosure also relates to the prepared nanocrystals and their uses.

### TECHNICAL FIELD

The present invention relates to the technical field of nanocrystals of semiconductors.

More particularly, the present invention proposes a method for preparing nanocrystals comprising a semiconductor of ternary composition, typically of the type ABC₂, such as nanocrystals of CuInS₂ optionally coated with a layer of another semiconductor of the DE type such as ZnS.

The present invention also relates to novel luminescent materials prepared in this way and notably based on CuInS₂/ZnS core/shell nanocrystals, the emission of which covers the visible spectrum and the near infrared as well as to their different uses and notably for in vivo imaging.

### STATE OF PRIOR ART

Two main types of labels which are fluorescent in the near infrared which is the range of wavelengths for which absorption and scattering of light by biological tissues are minimal, have been developed for in vivo imaging. These labels are either molecular fluorescent labels, i.e. organic fluorophores absorbing/emitting in the near infrared, i.e., nanoparticulate fluorescent labels.

The only organic fluorophore allowed today for injection into humans is IndoCyanine Green (or ICG). Unfortunately, this fluorophore is not very soluble in an aqueous buffer, does not include any chemical group allowing it to be grafted onto a biological target ligand, such as a peptide, an antibody or a protein, and is substantially adsorbed on plasma proteins. Clinical applications using ICG are presently essentially applications in imaging of vascularization, such as eye angiography. This is why many other cyanines absorbing/emitting in the near infrared have been developed and patented during these recent years (Amersham, Molecular Probes, Schering, Li-Cor, Biosearch), the efforts applied for developing such cyanines or dealing with the improvement of their solubility and their functionalization with graft groups allowing them to be coupled to biomolecules which are biological process probes, such as peptides. These fluorophores, certain of which are today marketed at very high prices, are not to our knowledge and at this present day approved for injection in humans, although toxicity investigations in this direction are very certainly in progress at several suppliers. Some of these organic fluorophores are on the other hand used for fluorescent imaging of small animals. Thus the Visen corporation markets several probes based on organic fluorophores in order to view in small animals, blood flow, tumoral glucose consumption, osteoblastic activity, activity of metalloproteases, activity of cathepsins and of plasmine.

However, these fluorophores have drawbacks inherent to organic fluorophores absorbing/emitting in the near infrared: significant photo-bleaching rate, wide emission lines, low spectral shift between absorption and emission, and low emission quantum yields (10 to 15% in water for fluorophores emitting beyond 650 nm).

For these different reasons, semiconductor nanocrystals have appeared very rapidly as an interesting alternative as luminescent labels for biology. Semiconductor crystals are luminescent materials which have been known for several decades. In the years 1980-1990, it was shown that their emission spectrum depends on the size of the crystal when the latter becomes sufficiently small. For crystals for which the size is approximately located in the range from 1 to 10 nm called [symbol] nanocrystals [symbol] or [symbol] quantum boxes [symbol] , this dependency is extremely pronounced. In fact, the entire palette of the colors of the visible range and the near infrared and ultraviolet ranges may be obtained with semiconductor nanocrystals by suitably selecting their size and composition. In order to cover the visible and near infrared spectrum, which is very important in the field of display/illumination and biological labeling, the most investigated materials are cadmium chalcogenides (CdS, CdSe, CdTe) and lead chalcogenides (PbS, PbSe). However, the European Directive RoHS (Restriction of Hazardous Substances) provides the removal inter alia of lead, mercury and cadmium in Electrical and Electronic Equipment (EEE), marketed in Europe since Jul. 1, 2006. Also, because of their intrinsic toxicity, nanocrystals based on cadmium [1], on lead or arsenic [2] are not acceptable for a large number of applications as a biological label and in particular for in vivo labeling in the human body.

It is therefore indispensable to find alternative materials for making nanocrystals, while keeping the sought optical properties.

Generally, the optical quality of a luminescent material consisting of nanocrystals depends on several parameters, the most important of which are:
the size of the nanocrystals which adjusts the emission wavelength;
the size distribution of nanocrystals, which controls the emission line width;
the surface passivation of nanocrystals, responsible for the fluorescence quantum yield and for stability over time.

Roquesite of formula CuInS₂ (or CIS), a member of the family of ternary chalcopyrites, is an interesting material for the substitution of nanocrystals based on cadmium and lead. By its forbidden band width of 1.5 eV, it is possible to vary the emission wavelength of the CIS crystals in the visible spectrum and in the near infrared by changing their size. However, CIS nanocrystals generally exhibit very low fluorescence efficiency at room temperature, as testified by the literature.

There exist several methods for preparing CIS nanocrystals among which the method for decomposing precursors in an organic solvent at a high temperature gives access to a narrower size dispersion. Low size dispersion of the nanocrystals leads to a narrow emission spectrum, i.e., a pure emission color which is particularly advantageous for technological applications. The main synthesis routes are the following.

A first synthesis route was described in 2003 in the article of Castro et al. [3]. The latter proposed the use of (PPh₃)₂CuIn(SEt)₄, which is a monomolecular precursor, both a source of copper, indium and sulfur. This precursor is placed in a flask containing as a solvent dioctyl phthalate. The mixture, heated to 200° C., leads to the formation of a red powder. This powder is isolated, purified, dispersed in dioctyl phthalate and then heated to 250-300° C. A brown or black powder consisting of CIS nanocrystals is then obtained. A modification of this procedure comprises the addition of hexanethiol to the reaction mixture and gives access to nanoparticles which are soluble in an organic solvent [4]. The obtained CIS nanocrystals have a size comprised between 2 and 4 nm and the maximum florescence quantum yield is located around 5%. Another alternative of the method consists of triggering the reaction by UV radiation (photolysis) [5]. The main disadvantage of these approaches is the use of a monomolecular precursor which is not commercially available and which therefore has to be synthesized beforehand for example, by using the procedure described in the article of Banger et al., 2003 [6].

Nakamura et al. have more recently described a second synthesis route which uses individual sources of copper, indium and sulfur [7]. In this case, copper iodide and indium iodide dissolved in oleylamine as well as sulfur, dissolved in trioctylphosphine are mixed in octadecene which is used as a solvent. After heating the mixture to 160-240° C., the size of the obtained nanocrystals is 3.5-7.5 nm, respectively. However, the fluorescence quantum yield is low, below 0.1%. A value of 5% was obtained with the quaternary system, Zn—Cu—In—S, described in the same article.

Another very recent synthesis route uses copper and indium diethyldithiocarbamates, prepared beforehand by reaction of copper(II) chloride and of indium(III) chloride with sodium diethyldithiocarbamate [8]. Both of the precursors are mixed with oleic acid or dodecanethiol (stabilizer) in 1-octadecene (solvent). After heating the reaction medium to 200° C., the oleylamine is injected, triggering the reaction for forming the CIS nanocrystals with a size of 4-30 nm according to the selected parameters. No information concerning the photoluminescence properties of these crystals is given.

To summarize, the preparation methods described above allow CIS nanocrystals to be obtained in a wide range of sizes and with low size dispersion. However, they do not solve the problem of the fluorescence quantum yield which remains low (below 5%). Consequently, the applications envisioned for the CIS nanocrystals are limited to solar cells, which are based on the absorption properties of the nanoparticles and not on their fluorescence. In the state of the art, the use of CIS nanocrystals as emitters/fluorophores and in particular in biological labeling is not described.

### DISCUSSION OF THE INVENTION

The present invention provides a solution to the technical problems and disadvantages listed earlier.

Indeed, the present invention, first of all, proposes a novel method for synthesis of nanocrystals comprising a semiconductor ternary compound consisting of elements (A, B, C), called hereafter a ternary compound (A, B, C) and particularly in a stoichiometric form of formula ABC₂. This method completed by a step for coating with a shell, the external portion of which comprises another semiconductor of formula'DE, gives the possibility of obtaining nanocrystals, notably nanocrystals of the [symbol] core/shell [symbol] type and, in particular, core/shell nanocrystals of formula CIS/ZnS having a fluorescence quantum yield of more than 10% and great stability against photo-oxidation. Further, the methods according to the present invention used are very simple to apply, which facilitates the change of scale for making these nanocrystals in a larger amount.

Finally, the method of the present invention is remarkable since it not only allows preparation of CIS nanocrystals optimally coated with a shell of ZnS, but it may also be generalized to the preparation of nanocrystals comprising a semiconductor ternary compound (A, B, C) and particularly of formula ABC₂, optionally coated with a shell comprising at least one semiconductor of formula DE, with A representing a metal or metalloid in the oxidation state +I, B representing a metal or metalloid in the oxidation state +III, C representing an element in the oxidation state −II, D representing a metal or metalloid in the oxidation state +II and E representing an element in the oxidation state −II.

Thus, the present invention relates to a method for preparing a nanocrystal comprising a semiconductor ternary compound consisting of the elements A, B and C, and more particularly of formula ABC₂, with A representing a metal or metalloid in the oxidation step +I, B representing a metal or metalloid in the oxidation state in +III; and C representing an element in the oxidation state −II, said method (designated hereafter as method (1)) comprising the successive steps of:

a) preparing a mixture comprising at least one precursor of A, at least one precursor of B, and at least one precursor of C, at a temperature Tₐ;

b) maintaining the mixture obtained in step (a) at a temperature T_{b} greater than or equal to the temperature Tₐ;

c) bringing the mixture obtained in step (b) from the temperature T_{b} to a temperature T_{c} above the temperature T_{b};

d₁) optionally purifying the nanocrystals comprising a semiconducting ternary compound consisting of the elements A, B and C, and, more particularly of formula ABC₂, obtained in step (c).

The nanocrystal prepared according to the method of the invention comprises a semiconducting ternary compound consisting of the elements A, B and C, and, more particularly of formula ABC₂, with A representing a metal or metalloid in the oxidation step +I, B representing a metal or metalloid in the oxidation step +III and C representing an element in the oxidation state −II, this type of semiconductor being named I-III-IV.

A, the metal or metalloid in the oxidation step +I applied within the scope of the present invention, is advantageously selected from copper (Cu), silver (Ag) and their mixtures.

B, the metal or metalloid in the oxidation step +III applied within the scope of the present invention is advantageously selected from gallium (Ga), indium (In), aluminium (Al) and their mixtures.

C, the element in the oxidation state −II applied within the scope of present invention is advantageously selected from sulfur (S), oxygen (O), selenium (Se), tellurium (Te) and their mixtures.

As an example of a semiconducting ternary compound (A, B, C) comprised in the nanocrystal prepared according to the method of invention, mention may be made of CuIn₃Se₅, CuIn₃S₅, CuIn₅Se₈, CuIn₅S₈, Cu₂In₂Se₄, CuIn₇Seₙ . . . . Among the stoichiometric ternary compounds (A, B, C), semiconductors of formula ABC₂ are typically found, among which mention may notably be made of CuAlS₂, CuGaS₂, CuInS₂, CuAlO₂, CuGaO₂, CuInO₂, CuAlSe₂, CuGaSe₂, CuInSe₂, CuAlTe₂, CuGaTe₂, CuInTe₂, AgAlS₂, AgGaS₂, AgInS₂, AgAlO₂, AgGaO₂, AgInO₂, AgAlSe₂, AgGaSe₂, AgInSe₂, AgAlTe₂, AgGaTe₂, AgInTe₂ and their mixtures. In particular, the core of the nanocrystal prepared according to the method of the invention comprises a semiconductor of formula ABC₂ selected from CuInS₂, CuGaS₂, CuInSe₂, CuGaSe₂ and their mixtures and, more particularly said semiconductor is CuInS₂.

Advantageously, the nanocrystal prepared according to the method of the invention exclusively consists of a semiconductor as defined earlier (i.e. a ternary semiconductor consisting of the elements A, B and C and, more particularly, a semiconductor of formula ABC₂).

The nanocrystal prepared by the method (1) of the present invention has a diameter of less than 10 nm, notably less than 8 nm and, in particular, comprised between 1 and 6 nm.

Within the scope of the present invention, the applied precursor of A is selected from the group formed by a precursor of copper, a precursor of silver, and their mixtures. All the copper and silver precursors known to one skilled in the art and notably the precursors appearing as a liquid or solid may be used in the present invention.

Advantageously, the precursor of A is selected from salts of A, halides of A, oxides of A, and organometallic compounds of A. By [symbol] organometallic compound of A [symbol] , is more particularly meant a substituted compound of A, a carboxylate of A or a phosphonate of A.

By [symbol] substituted compound of A [symbol] , is meant within the scope of the present invention, a compound of formula R₁A wherein R₁ represents a hydrocarbon group with 1 to 20 carbon atoms such as an alkyl radical, an alkenyl radical, an alkoxy radical, an aryl radical, and an aryloxy radical.

By [symbol] carboxylate of A [symbol] , is meant within the scope of the present invention, a compound of formula R₂COOA wherein R₂ represents a hydrocarbon group with 1 to 20 carbon atoms such as an alkyl radical, an alkenyl radical, an alkoxy radical, an aryl radical, or an aryloxy radical.

By [symbol] phosphonate of A [symbol] , is meant within the scope of the present invention, a compound of formula R₃—P(OR₄)(OR₅)OA wherein:
R₃: represents a hydrocarbon group with 1 to 20 carbon atoms such as an alkyl radical, an alkenyl radical, an alkoxy radical, an aryl radical, or an aryloxy radical;
R₄ represents a hydrogen atom or a hydrocarbon group with 1 to 20 carbon atoms, such as an alkyl radical, an alkenyl radical, an alkoxy radical, an aryl radical, or an aryloxy radical; and
R₅ represents a hydrogen atom or a hydrocarbon group with 1 to 20 carbon atoms such as an alkyl radical, an alkenyl radical, an alkoxy radical, an aryl radical, or an aryloxy radical.

Within the scope of the present invention and unless indicated otherwise, by [symbol] alkyl group [symbol] is meant a linear, branched or cyclic alkyl group, optionally substituted, with 1 to 20 carbon atoms, notably with 1 to 15 carbon atoms and in particular, with 1 to 10 carbon atoms.

Within the scope of the present invention, by [symbol] alkenyl group [symbol] is meant a linear, branched or cyclic alkenyl group, optionally substituted, with 2 to 20 carbon atoms, notably with 2 to 15 carbon atoms and in particular, with 2 to 10 carbon atoms.

Within the scope of the present invention, by [symbol] alkoxy group [symbol] is meant an oxygen atom substituted with an alkyl as defined earlier.

Within the scope of the present invention, by [symbol] aryl group [symbol] , is meant a mono- or poly-cyclic aromatic group, optionally substituted, having from 6 to 20 carbon atoms, notably from 6 to 14 carbon atoms, in particular, from 6 to 8 carbon atoms.

Within the scope of the present invention, by [symbol] aryloxy group [symbol] is meant an oxygen atom substituted with an aryl as defined earlier.

Within the scope of the present invention, by [symbol] optimally substituted [symbol] is meant a radical substituted with one or more groups selected from: an alkyl group, an alkoxy group, a halogen, a hydroxy, a cyano, a trifluoromethyl or a nitro.

Within the scope of the present invention, by [symbol] halogen [symbol] is meant a fluorine, chlorine, bromine or iodine.

As examples of an A precursor which may be used within the scope of the present invention, when A is copper, mention may be made of copper chloride, copper iodide, copper acetate, copper acetylacetonate, copper stearate, copper palmitate, copper myristate, copper laurate, copper oleate, and their mixtures. More particularly, said copper precursor is copper iodide.

Within the scope of the present invention, the applied precursor of B is advantageously selected from the group formed by an indium precursor, a gallium precursor, and aluminium precursor and their mixtures. All the indium, aluminium and gallium precursors known to one skilled to the art and notably the precursors appearing as a liquid or solid may be used in the present invention.

Advantageously, the precursor of B is selected from the salts of B, the halides of B, the oxides of B and the organometallic compounds of B. By, [symbol] organometallic compounds of B [symbol] , is more particularly meant a tri-substituted B compound, a B carboxylate or a B phosphonate.

By [symbol] tri-substituted B compound [symbol] , is meant within the scope of the present invention a compound of formula (R₆)₃B, in which each R₆, either identical or different, represents a hydrocarbon group with 1 to 20 carbon atoms such as an alkyl radical, an alkenyl radical, an alkoxy radical, an aryl radical, and an aryloxy radical.

By [symbol] B carboxylate [symbol] is meant within the scope of the present invention a compound of formula (R₇COO)₃B, in which each R₇, either identical or different, represents a hydrocarbon group with 1 to 20 carbon atoms such as an alkyl radical, an alkenyl radical, an alkoxy radical, an aryl radical, or an aryloxy radical.

By [symbol] B phosphonate [symbol] , is meant within the scope of the present invention a compound of formula [R₈—P(OR₉)(OR₁₀)O]₃B wherein:
each R₈, either identical or different represents a hydrocarbon group with 1 to 20 carbon atoms such as an alkyl radical, an alkenyl radical, an alkoxy radical, an aryl radical, or an aryloxy radical;
each R₉, either identical or different, represents a hydrogen atom or a hydrocarbon group with 1 to 20 carbon atoms such as an alkyl radical, an alkenyl radical, an alkoxy radical, an aryl radical, or an aryloxy radical; and
each R₁₀, either identical or different, represents a hydrogen atom or a hydrocarbon group with 1 to 20 carbon atoms such as an alkyl radical, an alkenyl radical, an alkoxy radical, an aryl radical, or an aryloxy radical.

The alkyl, alkenyl, alkoxy, aryl and aryloxy radicals are as defined for the precursors of A.

As examples of precursors of B which may be used within the scope of the present invention, when B is indium, mention may be made of indium trichloride, triethyl-indium, indium triacetate, indium tri(acetylacetonate) indium trioctanoate, indium tristearate, indium trilaureate, indium tripalmitate, indium trimyristate, indium trioleate, and their mixtures. More particularly said indium precursor is indium acetate.

Within the scope of the present invention, the applied precursor of C is selected in the group formed by a precursor of sulfur, a precursor of oxygen, a precursor of selenium, a precursor of tellurium and their mixtures. All the sulfur, oxygen, selenium and tellurium precursors are known to one skilled in the art and notably the precursors existing as a liquid or solid may be used in the present invention.

The precursor of C is selected from elementary selenium dissolved in an organic solvent; elementary tellurium dissolved in an organic solvent; elementary sulfur dissolved in an organic solvent; an aliphatic thiol; a xanthate; an amine oxide; a phosphine selenide; a phosphine oxide; a compound of formula C′ (Si(Rn)₃)₂, wherein C′ represents an element selected from the group formed by S, Se and Te and each R₁₁, either identical or different, is a linear, branched or cyclic alkyl group, optionally substituted, with 1 to 10 carbon atoms, notably 1 to 6 carbon atoms and in particular 1 to 3 carbon atoms, and their mixtures.

Advantageously, the aliphatic thiol is of formula CₙH₂ₙ₊₁—SH with n representing an integer comprised between 1 and 25, notably between 5 and 20 and, in particular, between 8 and 18. As aliphatic thiols which may be used within the scope of the present invention, mention may be made of octanethiol (n=8), octadecanethiol (n=18), and dodecanethiol (n=12) and their mixtures.

By [symbol] xanthate [symbol] , is meant within the scope of the present invention a compound with a sequence (R₁₂OCS₂)ₙY with Y representing a metal or metalloid in the oxidation state +n and R₁₂ representing a hydrocarbon group with 1 to 20 carbon atoms such as an alkyl radical, an alkenyl radical, an alkoxy radical, an aryl radical, or an aryloxy radical. The alkyl, alkenyl, alkoxy, aryl, and aryloxy radicals are as defined for the precursors of A.

By [symbol] amine oxide [symbol] , is meant within the scope of the present invention a compound with a sequence (R₁₃)₃NO wherein each R₁₃, either identical or different, represents a hydrocarbon group with 1 to 20 carbon atoms such as an alkyl radical, an alkenyl radical, an alkoxy radical, an aryl radical, or an aryloxy radical. The alkyl, alkenyl, alkoxy, aryl, and aryloxy radicals are as defined for the precursors of A. As an amine oxide which may be used within the scope of the present invention, mention may be made of trimethylamine N-oxide (R₁₃=methyl).

Advantageously, the organic solvent in which elementary selenium, tellurium or sulfur is dissolved is selected from trialkylphosphines in which the alkyl group comprises from 4 to 12 carbon atoms and from alkenes. As examples of organic solvents which may be used, mention may be made of 1-octadecene, tributylphosphine and trioctylphosphine.

More particularly, the phosphine selenide and oxide which may be used within the scope of the present invention are respectively selected from trialkylphosphine selenides and trialkylphosphine oxides in which the alkyl group comprises from 4 to 12 carbon atoms.

The precursors of A, B and C applied within the scope of the present invention may be products which are commercially accessible or products for which one skilled in the art is at least aware of one simple preparation method. Thus, at least one of the precursors of A, B and C may have been optionally prepared beforehand before its introduction into the mixture of step (a) or been prepared in situ in said mixture.

The mixing of at least one precursor of A, at least one precursor of B and at least one precursor of C, i.e. the mixture prepared in step (a) of the method of the invention, is carried out in an organic solvent.

Advantageously, said organic solvent is an alkane, a secondary or tertiary amine, or an alkene having a boiling point above T_{c}, i.e. greater than the temperature selected for step (c) of the method according to the invention.

By [symbol] alkane [symbol] , is meant within the scope of the present invention, a linear, branched or cyclic alkane, optionally substituted, with 1 to 40 carbon atoms, notably 10 to 35 carbon atoms and in particular 14 to 30 carbon atoms. As an example, the alkanes which may be used within the scope of the present invention are hexadecane and squalane (C₃₀H₆₂).

By [symbol] secondary or tertiary amine [symbol] , is meant within the scope of the present invention, notably dialkylamines and trialkylamines, the alkyl group of which comprises from 4 to 24 carbon atoms, notably from 8 to 20 carbon atoms. As an example, the secondary (tertiary) amine, which may be used within the scope of the present invention, is dioctylamine (trioctylamine) which includes 8 carbon atoms per alkyl chain.

By [symbol] alkene [symbol] , is meant within the scope of the present invention, a linear, branched or cyclic alkene, optionally substituted, with 2 to 40 carbon atoms, notably 10 to 35 carbon atoms and, in particular 14 to 40 carbon atoms. As an example, an alkene which may be used within the scope of the present invention is squalene (C₃₀H₅O).

A solvent more particularly used for preparing the mixture of precursors in the method according to the invention is 1-octadecene (C₁₈H₃₆).

Further, the mixture of precursors in said solvent may further contain an element selected from the group formed by a stabilizer for the surface of the nanocrystals and a primary amine.

Indeed, the mixture of precursors in said solvent may further contain a stabilizer for the surface of the nanocrystals. By [symbol] stabilizer for the surface of the nanocrystals [symbol] , also called [symbol] stabilizing ligand [symbol] , is meant within the scope of the present invention, an organic molecule which binds to the surface of the nanocrystal and which thereby avoids aggregation of the nanocrystals. Any stabilizer known to one skilled in the art may be used within the scope of the present invention. Advantageously, said stabilizer is selected from thiols and notably aliphatic thiols as described earlier; the alkylphosphines and notably tri(alkyl)phosphines as described earlier; alkylphosphine oxides and phosphonic acids as described earlier; carboxylic acids and notably aliphatic or olefinic carboxylic acids such as lauric acid, myristic acid, palmitic acid, stearic acid, oleic acid or their mixtures.

Finally, the mixture of precursors in said solvent may also contain a primary amine. Advantageously, the primary amine is an alkyl amine, the alkyl group of which comprises from 4 to 24 carbon atoms, notably from 8 to 20 carbon atoms. As an example, the primary amines which may be used within the scope of the present invention are octylamine, dodecylamine, hexadecylamine (HDA) and oleylamine.

The concentration of the precursor of A, of the precursor of B and of the precursor of C in the mixture during step (a) of the method is comprised between 2.5 and 150 mmol/L, notably between 5 and 100 mmol/L and in particular between 10 and 20 mmol/L.

It should be noted that some of the stabilizers listed earlier are also sources of precursors applied in the method according to the invention and notably precursors of C, such as precursors of sulfur. In this case, it is clear that the total amount of a precursor also playing a role of stabilizer is much larger, in the mixture, than the amount defined above. Thus, the amount of a compound playing the role of a precursor and of a stabilizer is comprised between 10 mmol/L and 5 mol/L, notably between 100 mmol/L and 1 mol/L and in particular between 200 and 700 mmol/L.

Advantageously, the temperature Tₐ of the mixture of precursors during step (a) is less than 50° C., notably less than 40° C. and in particular less than 30° C. More particularly, the mixture of precursors is at room temperature. By [symbol] room temperature [symbol] , is meant a temperature of 20° C.±5° C.

Advantageously, step (a) of the method of the invention is carried out with stirring. Different means known by one skilled in the art may be used for stirring the mixture applied during step (a) of the method of the invention. As examples, the mixture may be stirred by using a stirrer, a magnetic bar, an ultrasound bar or a homogenizer.

Finally, step (a) of the method of the invention may be applied under a flow of an inert gas and notably under a flow of argon, of nitrogen or one of their mixtures.

The step (b) of the method of the invention aims at maintaining the mixture prepared in step (a) at a temperature of T_{b} greater than or equal to the initial temperature of the mixture, i.e. the temperature Tₐ as defined earlier. During this step the precursors of A and B may be transformed by reaction with the stabilizer molecules in the medium. As an example, indium triacetate may react with myristic acid in order to form indium trimyristate.

Advantageously, the temperature T_{b} of the mixture of precursors during step (b) is less than 100° C., notably comprised between 30° C. and 80° C., in particular, comprised between 40° C. and 60° C. More particularly, the mixture of precursors is at a temperature of about 50° C. By [symbol] temperature of about 50° C. [symbol] , is meant a temperature of 50° C.±5° C.

In a first alternative of the step (b) of the method according to the invention, the temperature T_{b} is equal to the initial temperature of the mixture, i.e. the temperature Tₐ of step (a). In this case, once mixing of the precursors is achieved, the latter mixture is maintained at the temperature of T_{b}=Tₐ for a duration comprised between 15 and 180 min, notably between 30 and 120 min and, in particular for a duration of about 60 min. By [symbol] duration of about 60 min [symbol] , is meant a duration of 60 min±10 min.

In a second alternative of the step (b) of the method according to the invention, the temperature T_{b} is greater than the initial temperature of the mixture, i.e. the temperature Tₐ of step (a). In this case, once mixing of the precursors is achieved, the latter mixture is brought from temperature Tₐ to temperature T_{b}. This transition may be accomplished in an increasing way either linearly or with at least one plateau. In a particularly advantageous way, this transition is accomplished in an increasing linear way notably with a ramp from 1 to 20° C. per second, notably a ramp from 2.5 to 15° C. per second and, more particularly, a ramp from 5 to 10° C. per second.

The step (b) is advantageously applied under a rough vacuum. Once step (b) is completed, purging with an inert gas such as argon, nitrogen or one of their mixtures, is carried out. Also, step (b) of the method of the invention is carried out with stirring and notably according to the embodiments contemplated earlier for step (a) of the method.

Step (c) of the method of the invention consists of gradually heating up the reaction mixture obtained in step (b) of the method of the invention from temperature T_{b} to a higher temperature, i.e. temperature T_{c}. During this step, formation and growth of the nanocrystals of the semiconductor ternary compound (A, B, C) occur.

Advantageously, the temperature T_{c} is greater than 150° C., notably greater than 180° C., in particular comprised between 180° C. and 300° C., and, more particularly, comprised between 200° C. and 270° C. Advantageously, the temperature T_{c} is of about 230° C. By [symbol] of about 230° C. [symbol] , is meant a temperature of 230° C.±20° C. and notably a temperature of 230° C.±10° C.

In a first alternative of step (c) of the method according to the invention, the passing from temperature T_{b} to temperature T_{c} is accomplished in a linear increasing way.

Advantageously, the linear increase in the temperature is carried out with a ramp from 0.5 to 20° C. per second, notably a ramp from 1 to 10° C. per second and, more particularly, a ramp from 1.5 to 5° C. per second.

In a second alternative of step (c) of the method according to the invention, the passing from the temperature T_{b} to the temperature T_{c} is accomplished in an increasing way with at least one plateau.

By [symbol] plateau [symbol] , is meant a temperature T comprised between T_{b} and T_{c} which is maintained constant for a time comprised between 5 sec and 1 hr, notably between 15 sec and 45 min, in particular between 30 sec and 30 min and, more particularly between 1 min and 15 min. The increase in temperature between the temperatures T_{b} and T_{c} may have from 1 to 10 plateaus and notably from 2 to 5 plateaus. Between T_{b} and the first plateau, between two consecutive plateaus and between the last plateau and T_{c}, the temperature is increased linearly under conditions as defined for the first alternative of step (c).

During step (c), once the temperature T_{c} is reached, this temperature may be maintained constant for a duration comprised between 10 min and 5 hrs, notably between 20 min and 3.5 hrs and, in particular, between 30 min and 2 hrs. Advantageously, the duration of step (c) is of about 40 min. By [symbol] duration of about 40 min [symbol] , is meant a duration of 40 min±10 min and notably a duration of 40 min±5 min.

One skilled in the art is aware of different techniques and of different means with which the mixture of precursors may be gradually brought from temperature Tₐ to temperature T_{b} and from temperature T_{b} to temperature T_{c}. As examples, mention may be made of the use of a programmably thermostated flask or reactor containing the mixture of precursors, or the use of a bath heated beforehand to the required temperature which may be the temperature of a plateau, the temperature T_{b} or the temperature T_{c}, in which bath the flask or the reactor containing the mixture of precursors is immersed.

Step (c) is advantageously carried out with stirring and notably according to the embodiments contemplated earlier for step (a) of the method.

During a step (d₁) of the method according to the invention, the obtained nanocrystals are purified from the reaction mixture, i.e. the nanocrystals are separated from said reaction mixture. One skilled in the art is aware of different techniques for this purification applying a precipitation step, a dilution step and/or a filtration step. The techniques applied in the prior art for purifying luminescent nanocrystals may be used within the scope of step (d₁) of the method of the invention.

Advantageously, step (d₁) of the method is applied at a temperature below the temperature T_{c}. Thus, the obtained reaction medium following step (c) of the method is cooled or left to cool down to room temperature. Next, the nanocrystals are purified by precipitation while using a solvent or a mixture of suitable solvents.

For example, a mixture of an alcohol such as methanol and of chloroform (advantageously in a vol:vol proportion of 1:1) may be used for diluting the reaction mixture obtained following step (c), to a double volume, and then precipitating with an excess of acetone. The nanocrystals are recovered by centrifugation and may then be dispersed in organic solvents such as hexane, toluene or chloroform. The purification step (d₁) of the method according to the invention may possibly be repeated one or several times.

It is clear for one skilled in the art that there exist two main means for controlling the size of the nanocrystals of a ternary composition (A, B, C) obtained by the method (1) according to the invention and therefore their emission colour. These main means are (1) the reaction time and (2) the adjustment of the reaction parameters. One skilled in the art will therefore be able to adapt, without any inventive effort, these parameters in order to obtain a nanocrystal with a ternary composition (A, B, C) having a particular emission colour.

The method (1) according to the present invention gives the possibility of obtaining nanocrystals with a ternary composition (A, B, C) and particularly of formula ABC₂ having an interesting observed maximum fluorescence quantum yield. As an example, when the nanocrystal prepared according to the method of the present invention is a CIS nanocrystal, the maximum observed fluorescence quantum yield is of the order of 8%.

A method widely used for increasing the quantum yield of nanocrystals of diverse materials (e.g. CdSe, CdS, etc.) consist of passivating their surface by growing around the nanocrystal corresponding to the [symbol] core [symbol] , a shell of a semiconductor with a larger forbidden bandwidth. This system is described as a [symbol] core/shell [symbol] system in the scientific literature. The methods used for depositing the shell are essentially the same as the ones used for preparing the core. In order to improve the properties of the nanocrystals of ternary composition (A, B, C), the present invention proposes that they be covered with a shell of a DE semiconductor, D representing a metal or metalloid in the oxidation state +II and E representing an element in the oxidation state −II.

The present invention therefore proposes a method for preparing a nanocrystal having (i) a core comprising a semiconductor of ternary composition (A, B, C), and more particularly of formula ABC₂, with A representing a metal or metalloid in the oxidation step +I, B representing a metal or metalloid in the oxidation step +III and C representing an element in the oxidation state −II, coated with (ii) a shell, the external portion of which comprises a semiconductor of formula DE with D representing a metal or metalloid in the oxidation step +II and E representing an element in the oxidation step −II. A semiconductor of formula DE is also named More particularly, the semiconductor applied in the external portion of the shell is of formula ZnS₁₋ₓFₓ, with F representing an element in the oxidation state −II and x being a decimal number such that 0≦x<1.

Thus, the present invention proposes a method for preparing a nanocrystal having (i) a core comprising a semiconductor of ternary composition (A, B, C), and, more particularly, of formula ABC₂, with A representing a metal or metalloid in the oxidation state +I, B representing a metal or metalloid in the oxidation state +III and C representing an element in the oxidation state −II, coated with (ii) a shell, the external portion of which comprises a semiconductor of formula ZnS₁₋ₓFₓ, with F representing an element in the oxidation state −II and X being a decimal number such that 0≦x<1, said method (designated hereafter as method (2)) comprising the steps of:

α) preparing a nanocrystal comprising a semiconducting ternary compound consisting of the elements A, B and C, and more particularly of formula ABC₂, according to a method as defined earlier, and then

β) coating the nanocrystal prepared in step (α) with a shell, the external portion of which comprises a semiconductor of formula ZnS₁₋ₓFₓ, with F representing an element in the oxidation state −II and x being a decimal number such that 0≦x<1.

The nanocrystal prepared by the method (2) of the present invention has a diameter of less than 15 nm, notably less than 12 nm and in particular less than 10 nm.

The shell of the nanocrystal prepared by the method (2) according to the invention has a thickness comprising between 0.3 and 6 nm, notably between 0.5 and 4 nm and in particular between 1 and 2 nm.

Any technique known to one skilled in the art giving the possibility of coating or surrounding a semiconductor nanocrystal with one or several layers of another (or other) semiconductor(s) may be used within the scope of step (β) of the method of the present invention. Said step (β) may be applied on the nanocrystals prepared by the method (1), either purified (i.e. following step (d₁)) or not (i.e. following step (c)).

Advantageously, the method (2) according to the present invention comprises the successive steps of:

a) preparing a mixture comprising at least one precursor of A, at least one precursor of B and at least one precursor of C at a temperature of T_{A};

b) maintaining the mixture obtained in step (a) at a temperature T_{b}≧to the temperature T_{A};

c) bringing the mixture obtained in step (b) from the temperature T_{b} to a temperature T_{c} above the temperature T_{b};

d₂) adding to the mixture obtained in step (c) and maintained at temperature T_{c}, at least one zinc precursor, at least one sulfur precursor and optionally at least one precursor of F;

e2) purifying the nanocrystals having a core comprising a semiconductor ternary compound consisting of the elements A, B and C, and, more particularly, of formula ABC₂, coated with a shell, the external layer of which comprises a semiconductor of formula ZnS₁₋ₓFₓ, obtained in step (d₂).

The different embodiments and alternatives contemplated for the steps (a), (b) and (c) of the method (1) according to the invention apply mutatis mutandis to the steps (a), (b) and (c) of the method (2) according to the invention.

The nanocrystal prepared according to the method (2) of the present invention has a shell, the external portion of which comprises a semiconductor of formula ZnS₁₋ₓFₓ, with F representing an element in the oxidation state −II and x being a decimal number such that 0≦x<1. F is an element with an oxidation state −II notably selected from oxygen (O), selenium (Se), tellurium (Te) and their mixtures.

The shell of the nanocrystal prepared according to the method (2) of the invention may consist of a single layer or of several layers (i.e. be a multilayer shell). In the case when the shell only consists of one layer, the external portion of the shell corresponds to said layer.

In the case when the shell consists of several layers, the external portion of the shell corresponds to the external layer of the shell. By [symbol] external shell [symbol] , is meant within the scope of the present invention, the layer of the shell which is the most distant from the core of the nanocrystal and in direct contact with the medium or the environment in which the nanocrystal is found. A multilayer shell may comprise from 2 to 10, notably from 2 to 5 layers of different semiconductors. Thus, different alternatives may be contemplated for the shell of the nanocrystal prepared by the method of the invention.

In a first alternative, x in the formula ZnS₁₋ₓFₓ is equal to 0 and the shell is only formed with one layer which is therefore a layer of ZnS.

In a second alternative, x in the formula ZnS₁₋ₓFₓ is such that 0<x<1 and the shell is only formed with one layer.

In a third alternative, x in the formula ZnS₁₋ₓFₓ is equal to 0 and the shell comprises at least two different layers among which the external layer is a ZnS layer.

In a fourth alternative, x in the formula ZnS₁₋ₓFₓ is such that 0<x<1 and the shell comprises at least two different layers.

Further, the layer(s) of the shell of the nanocrystal prepared according to the method (2) of the invention may have a uniform chemical composition or, in the interior of a same layer, a chemical composition which differs and notably a chemical composition in the form of a gradient. In this scenario, the external portion of the shell will be formed by the external area of a shell with one layer and by the external area of the external layer of a multilayer shell.

When the shell is multilayer, the layer(s) comprised between the core of the nanocrystal and the external layer of formula ZnS₁₋ₓFₓ as defined earlier may comprise a semiconductor of ternary composition (A, B, C), and, more particularly, of formula ABC₂, as defined earlier and/or a semiconductor of formula DE as defined earlier.

The metal or metalloid D in the oxidation state +II, is notably selected from magnesium (Mg), calcium (Ca), strontium (Sr), barium (Ba), zinc (Zn), cadmium (Cd), mercury (Hg), tin (Sn), lead (Pb) and their mixtures. The element in the oxidation state −II is notably selected from oxygen (O) sulfur (S), selenium (Se), tellurium (Te) and their mixtures. Examples of semiconductors which may be present in the layers comprised between the core of the nanocrystal and the outside layer of the shell are for example, MgS, MgSe, MgTe, CaS, CaSe, CaTe, SrS, SrSe, SrTe, BaS, BaSe, BaTe, ZnO, ZnS, ZnSe, ZnTe, CdS, CdSe, CdTe, HgS, HgSe, HgTe, SnS, SnSe, SnTe, PbS, PbSe, PbTe and their mixtures. More particularly, examples of semiconductors which may be present in the layers comprised between the core of the nanocrystal and the external layer of the shell are selected from the group formed by Mgs, MgSe, MgTe, CaS, CaSe, CaTe, SrS, SrSe, SrTe, BaS, BaSe, BaTe, ZnO, ZnS, ZnSe, ZnTe, SnS, SnSe, SnTe and their mixtures.

It is therefore clear that in the case of a multilayer shell, the reaction mixture applied within the scope of the present invention and notably in step (d2) further contains the precursors of the elements forming the layers other than the external layer of the shell.

Step (d₂) gives the possibility of adding to the mixture obtained in step (c), i.e. to the mixture containing the nanocrystals of type (A, B, C), and notably ABC₂, forming the core of the nanocrystals prepared by applying the method (2), the precursors of the shell(s) surrounding or coating such a core on the one hand and, of maintaining the mixture at temperature T_{c} at which the shell is formed, on the other hand.

All the precursors applied within the scope of the method (2) of the present invention are either commercially accessible products or products for which one skilled in the art is aware of at least one preparation method. Thus, at least one of the precursors of zinc, sulfur and F may have been optionally prepared beforehand before its introduction into the mixture of step (d₂) or be prepared in situ in said mixture.

Within the scope of the present invention, the applied zinc precursor is selected in the group formed by zinc salts, zinc halides, zinc oxides and organometallic zinc compounds, by [symbol] organometallic zinc compounds [symbol] , is more particularly meant a bi-substituted zinc compound, a zinc carboxylate or a zinc phosphonate.

By [symbol] bi-substituted zinc compound [symbol] , is meant within the scope of the present invention, a compound of formula (R₁₄)₂Zn in which each R₁₄, either identical or different, represents a hydrocarbon group with 1 to 20 carbon atoms such as an alkyl radical, an alkenyl radical, an alkoxy radical, an aryl radical and an aryloxy radical.

By [symbol] zinc carboxylate [symbol] , is meant within the scope of the present invention a compound of formula (R₁₅COO)₂Zn in which each R₁₅, either identical or different, represents a hydrocarbon group with 1 to 20 carbon atoms such as an alkyl radical, an alkenyl radical, an alkoxy radical, an aryl radical or an aryloxy radical An advantageously applied carboxylate is zinc stearate.

By [symbol] zinc phosphonate [symbol] , is meant within the scope of the present invention, a compound of formula [R₁₆—P(OR₁₇)(OR₁₈)O]₂Zn wherein:
each R₁₆, either identical or different, represents a hydrocarbon group with 1 to 20 carbon atoms such as an alkyl radical, an alkenyl radical, an alkoxy radical, an aryl radical or an aryloxy radical;
each R₁₇, either identical or different, represents a hydrogen atom, a hydrocarbon group with 1 to 20 carbon atoms such as an alkyl radical, an alkenyl radical, an alkoxy radical, an aryl radical or an aryloxy radical; and
each R₁₈, either identical or different, represents a hydrogen atom, a hydrocarbon group with 1 to 20 carbon atoms such as an alkyl radical, an alkenyl radical, an alkoxy radical, an aryl radical or an aryloxy radical;

The alkyl, alkenyl, alkoxy, aryl and aryloxy radicals are as defined for the precursors of A.

Within the scope of the present invention, the applied precursor of sulfur is selected from the group formed by an aliphatic thiol, elementary sulfur dissolved in an organic solvent, a xanthate and a compound of formula S(Si(R₁₉)₃)₂ wherein each R₁₉, either identical or different, is a linear, branched or cyclic alkyl group, optionally substituted, with 1 to 10 carbon atoms, notably with 1 to 6 carbon atoms and, in particular with 1 to 3 carbon atoms.

The precursors of sulfur such as the aliphatic thiol and the xanthates, and the embodiments of the latter like the organic solvent used, are as defined earlier.

Within the scope of the present invention, the precursor of F optionally applied in step (d₂) is selected from the group formed by a precursor of oxygen, a precursor of selenium, a precursor of tellurium, and their mixtures.

Advantageously, the precursor of F is selected from elementary selenium dissolved in an organic solvent; elementary tellurium dissolved in an organic solvent; zinc acetate; phosphine selenide; phosphine oxide; a compound of formula F′(Si (R₂₀)₃)₂ wherein F′ represents Se or Te and each R₂₀, either identical or different, is a linear, branched or cyclic alkyl group, optionally substituted, with 1 to 10 carbon atoms, notably with 1 to 6 carbon atoms and, in particular, with 1 to 3 carbon atoms, and their mixtures.

The precursors of F like phosphine selenides and oxide, and the embodiments of the latter like the organic solvent used, are as defined earlier.

The concentration of the zinc precursor and of that of the sulfur precursor optionally with the precursor of F is comprised between 5 and 400 mmol/L, notably between 10 and 300 mmol/L and in particular between 20 and 200 mmol/L.

When the shell of the nanocrystal is a multilayer, the precursors of the various elements, the metals and metalloids forming the layers other than the external layer of the shell are present, in the reaction medium, at a concentration comprised between 5 et 400 mmol/L, notably between 10 and 300 mmol/L and in particular between 20 and 200 mmol/L.

The addition of precursors of zinc, of sulfur, and optionally of F and of other metals, of metalloids or elements forming the internal layers of the shell during step (d₂) may be accomplished in different ways.

In a first alternative, the precursors to be added are mixed beforehand with each other and the thereby obtained mixture is added in a single time to the mixture of the step (c).

In a second alternative, the precursors to be added are mixed beforehand with each other and the thereby obtained mixture is added at least twice to the mixture of step (c). In this alternative, the mixture of precursors is advantageously added dropwise.

In a third alternative, the precursors to be added are added independently of each other to the mixture of step (c), each precursor may be added to said mixture in a single go or in at least two times, or even dropwise.

In a fourth alternative, some precursors are mixed together and the thereby obtained mixture(s) is(are) added to the mixture of step (c) once or at least twice, or even dropwise, while at least one other precursor is added, independently of this(these) mixture(s), to the mixture of step (c) and this once or at least twice, or even dropwise.

Regardless of the applied alternative for adding the precursors, the latter may be added in solid form notably as a powder or as a solution. When at least one precursor among the precursors of zinc, sulfur, and optionally of F and other metals, metalloids or elements making up the internal layers of the shell is added into the solution, this solution comprises as a solvent, an organic solvent as defined earlier.

The temperature of the mixture during step (d₂) is maintained at temperature T_{c} as defined earlier. It should be noted that it may be necessary to bring the temperature of the mixture of step (c) to the temperature T_{c}, if the temperature of said mixture decreases between steps (c) and (d₂). The different means and embodiments for bringing and/or maintaining the mixture to the temperature T_{c} during step (d₂) are identical with those contemplated for steps (b) and (c).

The step (d₂) advantageously has a duration comprised between 5 min and 5 hrs, notably between 10 min and 3.5 hrs and in particular between 20 min and 2 hrs. Advantageously, the duration of step (d₂) is of about 30 min. By [symbol] duration of about 30 min [symbol] , is meant a duration of 30 min±10 min and notably a duration of 30 min±5 min. The precursors of zinc, sulfur, of F and of other metals, metalloids or elements making up the internal layers of the shell may be added to the mixture during the whole duration of the step (d₂) or after having been added within the first minutes of step (d₂). By [symbol] first minutes [symbol] , are meant within the scope of the present invention the 1^{st}, the 1^{st} 2, the 1^{st} 5, the 1^{st} 15 minutes of step (d₂).

The purification step (e₂) of the method (2) is a step for purification/separation of the thereby prepared core/shell nanocrystals to which apply the embodiments and the alternatives contemplated earlier for step (d₁).

The present invention relates to any nanocrystal which may be obtained by a method according to the present invention, i.e.:
either a nanocrystal comprising a semiconductor of ternary composition (A, B, C), and, more particularly of formula ABC₂;
or a nanocrystal having (i) a core comprising a semiconductor of ternary composition (A, B, C), and more particularly of formula ABC₂, with A representing a metal or metalloid in the oxidation state +I, B representing a metal or metalloid in the oxidation state +III and C representing an element in the oxidation state −II, coated with (ii) a shell, the external portion of which comprises a semiconductor of formula ZnS₁₋ₓFₓ, with F representing an element in the oxidation state −II and x being a decimal number such that 0≦x<1.

More particularly, the present invention relates to a nanocrystal having a core comprising a semiconductor comprising copper, indium and sulfur, coated with a shell, the external portion of which comprises a semiconductor comprising zinc and sulfur, which may be obtained by a method according to the invention.

Indeed, the use of a semiconducting material comprising zinc and sulfur in the external portion of the shell has several advantages.

1) this material is non-toxic and has good chemical stability;

2) its lattice cell parameter (5.41 Å) is close to that of the CIS core (5.52 Å) i.e. a cell mismatch of about 2%, a small cell mismatch between the core and shell materials being indispensable in order to be able to grow the shell epitaxially and to thereby avoid the formation of crystalline defects which may reduce fluorescence efficiency;

3) its greater forbidden band width of 3.8 eV (“band gap”) and its alignment of energy bands with respect to the CIS ensure confinement in the CIS of charge carriers generated upon a photo-excitation. Accordingly, the ZnS cell has no influence (or very little) on the emission wavelength. On the other hand, the fluorescence intensity and photostability may be considerably improved by the better passivation of the CIS surface and its physical separation from the surrounding medium by the ZnS shell.

More particularly, the nanocrystal object of the present invention, i.e. having a core comprising a semiconductor comprising copper, indium and sulfur, coated with a shell, the external portion of which comprises a semiconductor comprising zinc and sulfur, which may be obtained by a method according to the invention, has a higher fluorescence quantum yield than the values reported to this day. The fluorescence quantum yield with the nanocrystals according to the invention is greater than 5% at room temperature, notably greater than 10% at room temperature, in particular greater than 20% at room temperature, and more particularly greater than 50%.

One skilled in the art is aware of different techniques with which for a given nanocrystal, it is possible to obtain its fluorescence quantum yield at room temperature. As an example, mention may be made of the technique consisting of comparing the spectrally integrated emission intensity of a dispersion of nanocrystals according to the invention in hexane with optical density X at an excitation wavelength Y with that of a solution of rhodamine G6 in ethanol with the same optical density and at the same excitation wavelength.

The nanocrystal having a core comprising a semiconductor comprising copper, indium, and sulfur, coated with a shell, the external portion of which comprises a semiconductor comprising zinc and sulfur, object of the present invention, emits in the near infrared, advantageously in the spectral range from 500 to 900 nm and notably in the spectral range from 650 to 900 nm, which is particularly interesting for optical imaging in vivo.

The present invention also relates to a composition comprising at least one nanocrystal having a core comprising a semiconductor comprising copper, indium, and sulfur, coated with a shell, the external portion of which comprises a semiconductor comprising zinc and sulfur in an aqueous medium. Said composition is advantageously a liquid composition.

By [symbol] aqueous medium [symbol] , is meant within the scope of the present invention, a medium selected from the group formed by water, demineralized water, deionized water, a saline solution such as PBS, a physiological saline solution, a sodium chloride solution, aqueous acetic acid, a mixture of water and of an organic solvent as defined earlier and their mixtures.

Indeed once they are synthesised, the nanocrystals according to the present invention are in an organic medium and need to be transferred into an aqueous medium before any use in biology and in particular for molecular imaging in vivo.

The passing of the nanocrystals into the aqueous medium is generally carried out by any technique known to one skilled in the art. These techniques involve (i) an exchange of ligands (i.e. the initial ligands stabilizing the nanocrystals in an organic medium are exchanged with the ligands which will stabilize the nanoparticles in an aqueous medium, (ii) the formation of an intermediate layer between the nanocrystal and the aqueous medium such as a silica layer or further (iii) the hydrophobic/hydrophobic interaction with at least one amphiphilic polymer with the hydrophobic portion of the polymer interacting with the initial organic ligands stabilizing the nanocrystals, and the hydrophilic portion used for stabilizing said nanocrystals in an aqueous buffer. For all these techniques, one refers to functionalization of the nanocrystals.

Therefore, the method (2) according to the present invention may have an additional step aiming at functionalising the purified nanocrystals after step (e₂).

More particularly, within in the scope of ligand exchange, the passing of the nanocrystals into the aqueous buffer is achieved under conditions which promote a maximum exchange rate of the ligands such as dodecanethiol by the new amphiphilic ligands and the stability of the thereby functionalized nanocrystals in an aqueous suspension. Any amphiphilic ligand known to one skilled in the art may be used in this functionalization. As examples, mention may be made of amphiphilic ligands of the mercaptocarboxylic acid type of the β-diketone type and dihydrolipoic acid type. The latter has a small size, a charged group for promoting solubilization in water, and two thiol functions known for their great affinity with the surface of the nanocrystals including a zinc sulfide shell.

The present invention finally relates to the use of a nanocrystal, which may be prepared according to a method of the invention or of a nanocrystal according to the invention in a light-emitting diode or in a photovoltaic cell.

The present invention finally relates to the use of a nanocrystal which may be prepared according to a method of the invention, of a nanocrystal according to the invention or of a composition according to the present invention for fluorescent labeling of chemical or biological molecules.

In order to summarize the particular advantages provided by the present invention, the benefit of the proposed method is multiple:

1. It produces nanocrystals based on CIS/ZnS having a higher fluorescence quantum yield than the nanocrystals known up to now and notably greater than 20% at room temperature in the visible spectrum (480-650 nm) and greater than 5% in the near infrared (650-900 nm).

2. It gives access to CIS/ZnS nanocrystals emitting in the near infrared and notably in the spectral range of 650-900 nm, particularly of interest for optical imaging in vivo.

3. It is very simple, which facilitates a change in scale in order to increase the amount produced. In particular, no pyrophoric precursor is used and the steps for synthesizing core and core/shell crystals are in direct succession, i.e. without any intermediate purification of the core CIS crystals. Further, no size-sorting step (e.g. by selective precipitation) is required because of the low size dispersion of the samples obtained directly after synthesis.

4. After adequate functionalization of the surface, the CIS/ZnS nanocrystals may be transferred into an aqueous medium and used as a fluorescent label in biology. They do not include cadmium, lead or mercury, heavy metals which have acute or chronic toxicity. Their emission properties are sufficiently performing so as to allow detection of their biodistribution in vivo without sacrificing the animal in Nude mice at doses of the order of 10¹⁷ copper atoms/mouse of 20 g.

Other features and advantages of the present invention will further become apparent to one skilled in the art upon reading the examples below given as an illustration and not as a limitation, and referring to the appended figures.

### BRIEF DESCRIPTION OF THE DRAWINGS

FIG. 1 shows the UV-visible absorption spectra from samples taken during the experiment described in part II hereafter (synthesis of CIS nanocrystals) by using a reaction temperature of 200° C.

FIG. 2 shows the photoluminescence spectra of the samples taken during the experiment described in part II hereafter (synthesis of CIS nanocrystals). The excitation wavelength is 470 nm.

FIG. 3 shows the photoluminescence spectra of CIS/ZnS samples prepared according to part III hereafter by using photosynthesis of core CIS nanocrystals. A temperature of 230° C. and a reaction time of 20 min (FIG. 3A); 40 min (FIG. 3B); 60 min (FIG. 3C). The excitation wavelength is 470 nm.

FIG. 4 shows an X-ray powder diffractogram of the core CIS nanocrystals prepared by heating to 270° C. for 30 min (Curve A), core CIS nanocrystals prepared by heating to 230° C. for 40 min (Curve B), and a core/shell CIS/ZnS nanocrystal (Curve C), made from sample B.

FIG. 5 shows transmission electron microscopy images of a sample of core CIS nanocrystals prepared by heating to 230° C. for 40 min (FIG. 5A) and of the core/shell CIS/ZnS sample corresponding to the same magnification (FIG. 5B).

FIG. 6 shows the photoluminescence spectra of the CIS—ZnS nanocrystals before and after being transferred into an aqueous buffer PBS 1× (excitation at 590 nm).

FIG. 7 shows the fluorescence images showing the biodistribution over time of CIS—ZnS nanocrystals (6.5.10¹⁶-1.3.10¹⁷ copper atoms) injected via an intravenous route (caudal vein) in healthy Nude mice.

### DETAILED DISCUSSION OF CERTAIN EMBODIMENTS

All the handling operations of air-sensitive materials are carried out in a glove box or by using a vacuum ramp (Schlenk technique).

I. Equipment and Methods.

For the characterization, the UV-visible absorption spectra were measured on a Hewlett-Packard 8452A spectrometer (spectral wavelength range: 190-820 nm, 2 nm resolution), the photoluminescence spectra were acquired with a Hitachi F-4500 spectrometer. For these spectroscopic measurements, diluted colloidal solutions of nanocrystals in hexane were placed in a quartz cuvette with an optical path of 1 cm. The fluorescence quantum yields at room temperature were obtained by comparing the spectrally integrated emission intensity of the solution of nanocrystals in hexane with that of a solution of rhodamine 6G in ethanol, both solutions having the same optical density (<0.03) at the excitation wavelength (490 nm). The XR diffractograms were obtained on a Philips X'Pert apparatus, using a Co source at 50 kV and 35 mA. The transmission electron microscopy images were acquired with a JEOL 4000FX microscope.

All the products except for zinc stearate (Riedel-de Haën) and copper iodide (Acros) were purchased from Sigma-Aldrich and used as such, indium acetate (99.99% purity), copper iodide (99.995% purity), zinc stearate (90% purity), dodecanethiol (97% purity) and 1-octadecene (90% purity). The synthesis of zinc ethyl xanthate used in growing the shell, is described subsequently: 0.005 mol of cadmium chloride is dissolved in 20 mL of distilled water. A solution of 0.01 mol of potassium xanthogenate dissolved in 20 mL of distilled water is added thereto. A white precipitate is thereby formed, which is filtered and then washed three times with 50 mL of distilled water and dried in vacuo.

II. Synthesis of CIS Nanocrystals.

II.A. Procedure.

Step 1: 0.3 mmol of copper iodine (I), 0.3 mmol of indium acetate (III), 12.5 mmol of 1-dodecanethiol and 25 mL 1-octadecene are placed in a three-neck flask of 50 mL equipped with a condenser and mixed under a flow of inert gas (argon or nitrogen) by means of a magnetic stirrer.

Step 2: This mixture is heated to 50° C. for 1 hour under a primary vacuum, and then is purged with nitrogen or argon.

Step 3: The reaction mixture is heated to 230° C., and is left with stirring at this temperature for 40 min. For the temperature rise, during which the reaction mixture becomes transparent, a ramp of about 150° C./minute is used.

Step 4: After cooling down to room temperature, the CIS nanocrystals may be isolated by adding a volume equivalent of a chloroform/methanol mixture (1:1 vol:vol) and 10 volume equivalents of acetone, and then by centrifugation. The resulting precipitate containing the nanocrystals may be dispersed in organic solvents such as hexane, toluene, or chloroform.

II.B. Characterisation of CIS Nanocrystals.

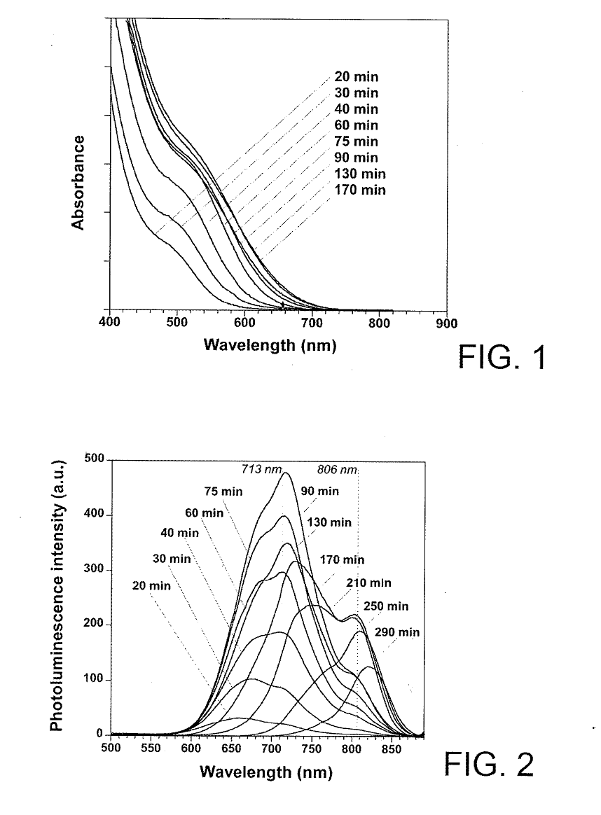

The UV-visible absorption and photoluminescence spectra of the CIS nanocrystals before coating with a ZnS shell, obtained during a synthesis carried out at 200° C., are shown in FIGS. 1 and 2, respectively.

In FIG. 1, the shift of the absorption threshold towards greater wavelengths is observed over time, indicating an increase in the size of the nanocrystals during the reaction. After 130 min, this time-dependent change stagnates.

In the photoluminescence spectra (FIG. 2), a signal is observed having its peak around 650 nm at 20 min. The peak moves with the reaction time towards greater wavelengths, which is accompanied by the occurrence of two peaks localized at about 713 and 806 nm. The relative intensity of these three signals also varies over time. The photoluminescence spectra of CIS generally have several lines, which originate from transitions involving electron states within the gap (semiconductor forbidden band). The latter are located in proximity to the valence band and close to the conduction band, giving rise to transitions of the donor-acceptor type, for example. The observed maximum fluorescence quantum yield of the core CIS crystals prepared according to the method of the present invention is of the order of 8%.

III. Synthesis of Core/Shell CIS/ZnS Nanocrystals.

III.A. Procedure.

For growing the ZnS shell, the reaction described in part II after step 3, i.e. before purification, is continued.

The temperature of the reaction mixture is maintained (or adjusted if the synthesis of CIS crystals was carried out at another temperature) at 230° C. and the ZnS precursors, a mixture of 2.5 mmol of zinc stearate and of 0.32 mmol of zinc ethylxanthate in 20 mL of 1-octadecene, are added dropwise for 30 min.

After cooling down to room temperature, purification of the CIS/ZnS nanocrystals is carried out in the same way as described for the CIS crystals, i.e. step 4 of part II.

III.B. Characterization of the Core/Shell CIS/ZnS Nanocrystals and Comparison with CIS Nanocrystals.

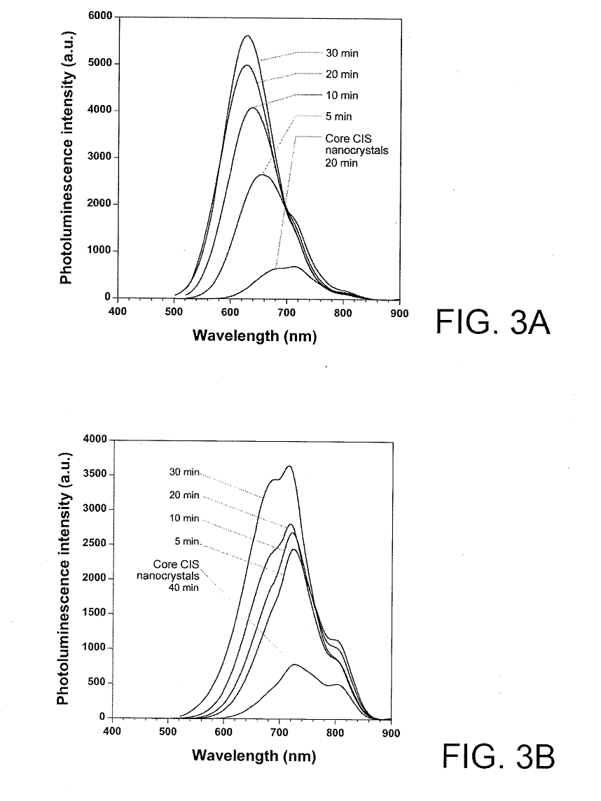

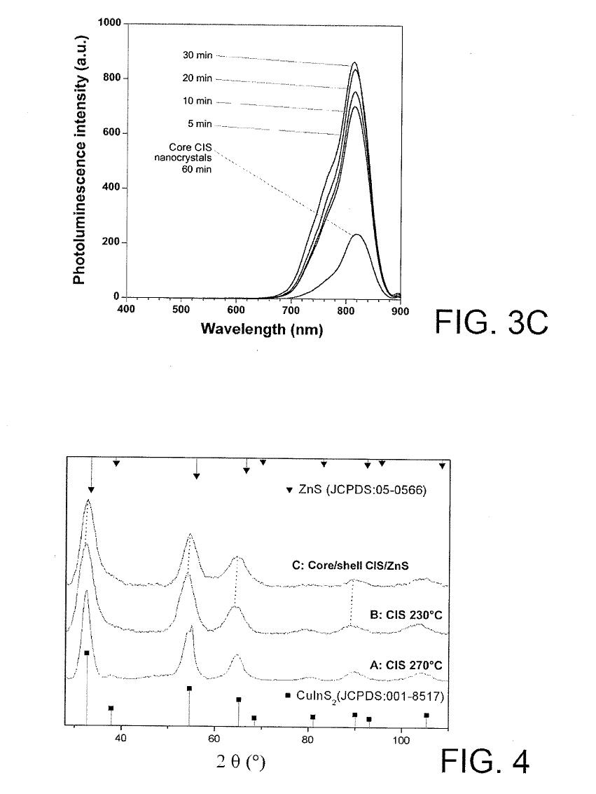

FIG. 3 shows the time-dependent change of the photoluminescence spectra during the growth of the ZnS shell on three different samples of CIS nanocrystals.

In FIG. 3A, a more symmetrical shape of the fluorescence line is observed simultaneously with narrowing of its width of 120 nm (FWHM, full width at half maximum) to 100 nm and an increase in the integrated intensity (500-900 nm) by a factor >7. The quantum yield of the sample was determined to be 61%.

The photoluminescence spectrum of the core CIS sample visible in FIG. 3B, has two distinct peaks at 723 and 802 nm, as well as a shoulder around 680 nm. During the coating with the ZnS shell, these are the peaks at 682 and at 723 nm, for which the intensity increases the most strongly. The integrated intensity increases by a factor 5 and the fluorescence quantum yield of the sample is 42%.

FIG. 3C shows that it is also possible to specifically increase the intensity of the line at a longer wavelength (810-820 nm). An improvement in the integrated intensity by a factor 4.1 is observed giving a quantum yield of 8%. These results show that it is possible to cover a large spectral range with CIS/ZnS nanocrystals. Coating with ZnS allows a significant increase in the fluorescence quantum yield.

In FIG. 4, the X-ray powder diffractograms obtained for core and core/shell samples, are compared.

The diffractograms of samples A and B show characteristic peaks of the cubic phase of CuInS₂ (map from the [symbol] Joint Committee on Powder Diffraction Standards [symbol] , JCPDS, No. 001-8517). Both of the samples contain CIS nanocrystals of different sizes. The width of the peaks, which is larger for sample B indicates that the size of the crystallites are smaller. The diffractogram of sample C confirms the formation of the CIS/ZnS hetero-structure. The peaks comprise both the contribution of the cubic phase of CIS and of the zinc blende structure ZnS (map JCPDS No. 05-0566).

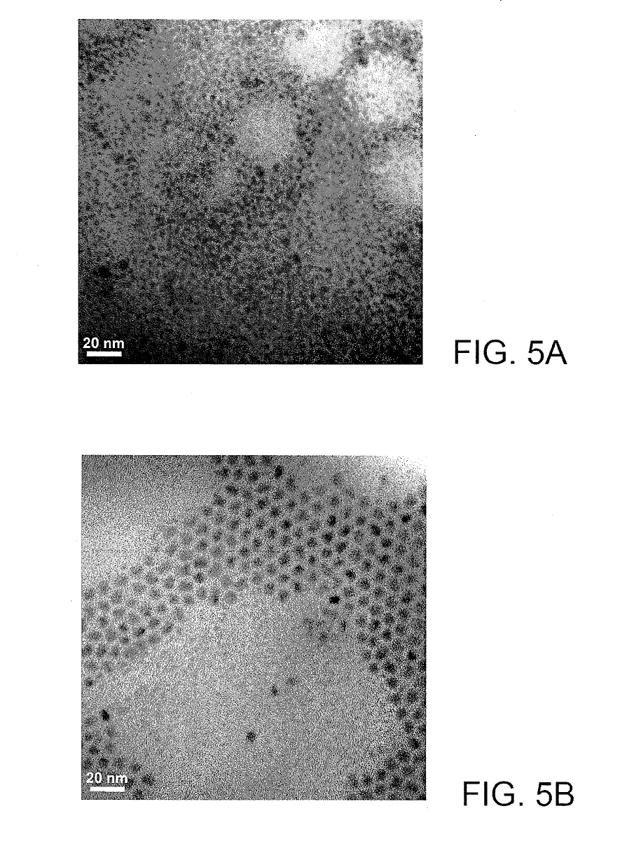

FIG. 5 compares transmission electron microscopy images of CIS nanocrystals before and after growing the ZnS shell. An increase in the average size from 3 nm to 7 nm is observed, corresponding to the deposit of a shell consisting of about 6 monolayers of ZnS. The size distribution of the core/shell sample is less than 10%.

III.C. Functionalization of the CIS/ZnS Nanocrystals.

All the products except for the NAP-5 (GE Healthcare) were purchased from Sigma-Aldrich.

In a first phase, in order to remove the excess of dodecanethiol used in the step for synthesizing the nanocrystals, the latter are washed twice by adding a non-solvent (ethanol) in the following way.

A solution of 250 μL of hexane containing CIS—ZnS nanocrystals (synthesized as described above) is placed in a 1.5 mL microtube. 250 μL of ethanol are added in order to cause precipitation of the nanocrystals. The microtube is centrifuged at the 13,000×g for 10 min on a Thermo Electro Corporation centrifuge, model HERAEUS PICO17. The CIS—ZnS nanocrystals are separated from the supernatant and then re-dispersed in 250 μL of hexane.

After the washing step, the nanocrystals are dried in vacuo at 50° C. Once the remainder of hexane and ethanol is evaporated, 40 μL of dihydrolipoic acid are added and the reaction mixture is heated to 70° C. with magnetic stirring. After two hours of heating, 1 mL of dimethylformamide is added in order to solubilize the contents. Next, potassium tert-butoxide excess is added, causing precipitation of the nanocrystals. The microtube is centrifuged at 13,000×g for 10 minutes on a Thermo Electro Corporation centrifuge, model HERAEUS PICO17. The CIS nanocrystals are separated from the supernatant and then re-dispersed in a buffer solution (0.01 M of sodium phosphate and 0.15 M of sodium chloride) with a pH of 7.4.

Finally, this solution of CIS/ZnS nanocrystals is purified on a NAP-5 Sephadex G-25 column (GE Healthcare) for removing the excess potassium tert-butoxide. A small amount of dihydrolipoic acid is added to the purified solution in order to increase the colloidal stability of the product.

IV. Intravenous Injection of Functionalized CIS/ZnS Nanocrystals.

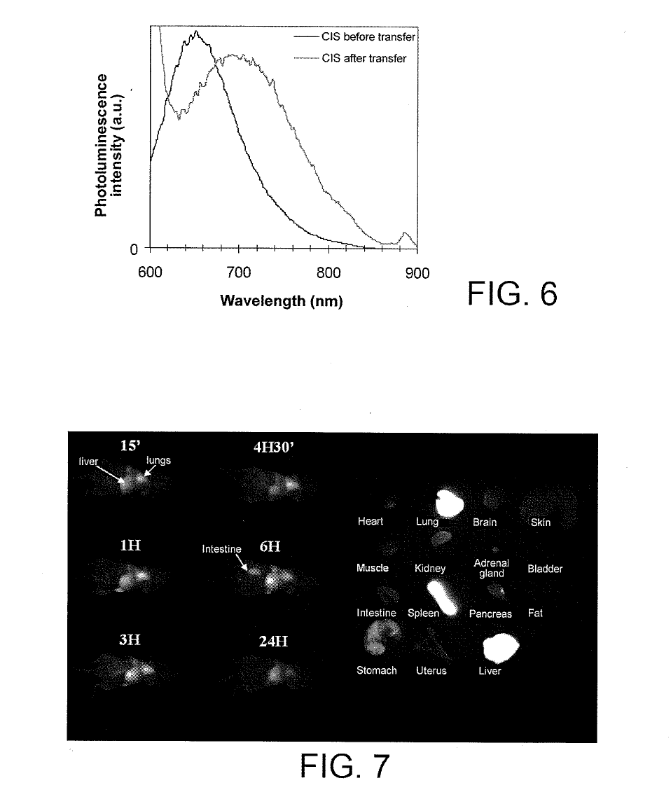

Once the exchange of ligands is achieved, three conditions have to be met in order to be able to use the product for biological applications, and notably for injecting it into small animals for fluorescence imaging in vivo. These conditions are the following:
knowledge of the concentration of the solutions: the different elements making up the nanocrystal present in the solution are assayed by inductively coupled plasma mass spectrometry analysis (ICP-MS) after treatment with 65% nitric acid;
the absence of agglomerates: The hydrodynamic diameter of the nanoparticles obtained in an aqueous buffer PBS 1× after ligand exchange is determined by means of the nanosizer NANO-ZS from Malvern: a hydrodynamic diameter of 17+/−3 nm is obtained;
a high optical signal for having good detection sensitivity. The optical properties of these nanocrystals are determined after passing into the aqueous phase. FIG. 6 illustrates the photoluminescence spectra obtained before and after passing into the aqueous buffer (excitation at 590 nm). A red shift of about 50 nm of the emission wavelength of the nanocrystals is observed after transfer into the aqueous buffer.

Once these conditions are met, 200 μL of the aqueous solution of functionalized CIS—ZnS nanocrystals corresponding to 6.5.10¹⁶-1.3.10¹⁷ copper atoms, are injected intravenously into the tail of female Nude mice of six to eight weeks of age, and maintained under conditions without any pathogens (IFFA-Credo, Marcy l'Etoile, France).

The mice were maintained under general anesthesia via a gas route (isoflurane) throughout the experiment. The anesthetized mice were imaged with a Fluorescence Reflection Imaging device (FRI), including as an excitation source a crown of LEDs provided with interference filters, emitting at 633 nm (illumination power of 50 μW·cm⁻² as described for example in the article of Texier et al., 2005 [9].

The images were collected after filtering with a colored filter RG665 with an optical density >5 at the excitation wavelength with a CCD camera (Orca BTL, Hamamatsu) with an exposure time of 500 ms. The signals were quantified by means of an image processing software package Wasabi.

FIG. 7 shows the time-dependent change in the fluorescence of the CIS—ZnS nanocrystals functionalized by dihydrolipoic acid in the mouse over a period of 24 hours. No modification of the behavior of the animal is observed for the 24 hours following the injection and no sign of toxicity is detected.

The nanocrystals are directed towards the liver and the lungs as soon as 15 min after the injection. Elimination via a fecal route is observed six hours after the injection. These non-invasive observations in vivo are confirmed by fluorescence analysis of the organs after sacrificing the animal after 24 hours.

As a conclusion, the CIS—ZnS nanocrystals functionalized by dihydrolipoic acid are adapted to fluorescence imaging in vivo. Their subsequent functionalization by different target ligands (antibodies, peptides, and saccharides) allowing them to be directed towards other areas of interest to be imaged, may be contemplated by grafting said target ligands onto the acid function of dihydrolipoic acid.

Further, elimination, at least partial elimination of these nanocrystals via a fecal route should allow them to be repeatedly used in imaging procedures, notably with the purpose of evaluating the efficiency of therapeutic treatments.

### REFERENCES

[1] H. S. Choi, W. Liu, P. Misra, E. Tanaka, J. P. Zimmer, B. I. Ipe, M. G. Bawendi, J. V. Frangioni, Nat. Biotechnol. 2007, 25, 1165-1170.
[2] J. P. Zimmer, S. W. Kim, S. Ohnishi, E. Tanaka, J. V. Frangioni, M. G. Bawendi, J. Am. Chem. Soc. 2006, 128, 2526-2527.
[3] S. L. Castro, S. G. Bailey, R. P. Raffaelle, K. K. Banger, A. F. Hepp, Chem. Mater. 2003, 15, 3142-3147.
[4] S. L. Castro, S. G. Bailey, R. P. Raffaelle, K. K. Banger, A. F. Hepp, J. Phys. Chem. B 2004, 108, 12429-12435.
[5] J. J. Nairn, P. J. Shapiro, B. Twamley, T. Pounds, R. von Wandruszka, T. R. Fletcher, M. Williams, C. M. Wang, M. G. Norton, Nano Lett. 2006, 6, 1218-1223.
[6] K. K. Banger, M. H. C. Jin, J. D. Harris, P. E. Fanwick, A. F. Hepp, Inorganic Chemistry 2003, 42, 7713-7715.
[7] H. Nakamura, W. Kato, M. Uehara, K. Nose, T. Omata, S. Otsuka-Yao-Matsuo, M. Miyazaki, H. Maeda, Chem. Mater. 2006, 18, 3330-3335.
[8] D. Pan, L. An, Z. Sun, W. Hou, Y. Yang, Z. Yang, Y. Lu, J. Am. Chem. Soc. 2008, 130, 5620-5621.
[9] Texier, I. et al., Proceedings of the SPIE 2005, 5704, 16-22.

What is claimed is:

1. A method for preparing a nanocrystal comprising a semiconductor ternary compound formed of the elements A, B and C, with A representing a metal or metalloid in the oxidation state +I, B representing a metal or metalloid in the oxidation step +III, and C representing an element in the oxidation state −II, the method comprising:
preparing a mixture comprising at least one precursor of A, at least one precursor of B and at least one precursor of C at a temperature Tₐ;
maintaining the prepared mixture at a temperature T_{b} greater than or equal to the temperature Tₐ; and
increasing the temperature of the prepared mixture from the temperature T_{b} to a temperature T_{c} above the temperature T_{b}.

2. A method for preparing a nanocrystal having a core comprising a semiconductor ternary compound formed of the elements A, B and C, with A representing a metal or metalloid in the oxidation state +I, B representing a metal or metalloid in the oxidation step +III, and C representing an element in the oxidation state −II, coated with a shell, the external portion of which comprises a semiconductor of formula ZnS₁₋ₓFₓ, with F representing an element in the oxidation step −II, and wherein x is a decimal number such that 0≦x<1, the method comprising:
preparing a nanocrystal comprising a semiconducting ternary compound consisting of the elements A, B and C according to a method as defined in claim 1,
coating the prepared nanocrystal with a shell, the external portion of which comprises a semiconductor of formula ZnS₁₋ₓFₓ, with F representing an element in the oxidation state −II and x being a decimal number such that 0≦x<1.

3. The method according to claim 2, further comprising:
a preparing a mixture comprising at least one precursor of A, at least one precursor of B and at least one precursor of C at a temperature Tₐ;
maintaining the prepared mixture at a temperature T_{b} greater than or equal to the temperature Tₐ;
increasing the temperature of the prepared mixture from from the temperature T_{b} to a temperature T_{c} above the temperature T_{b};
adding to the mixture maintained at temperature T_{c}, at least one precursor of zinc, and at least one precursor of sulfur; and
purifying the nanocrystals having a core comprising a semiconducting ternary compound consisting of the elements A, B and C, coated with a shell, the external layer of which comprises a semiconductor of formula ZnS₁₋ₓFₓ.

4. The method according to claim 1, wherein the ternary compound has a formula ABC₂.

5. The method according to claim 1, wherein the precursor of A is selected from the group consisting of a precursor of copper, a precursor of silver, and mixtures thereof.

6. The method according to claim 1, wherein the precursor of A is selected from the group consisting of salts of A, the halides of A, the oxides of A, and the organometallic compounds of A.

7. The method according to claim 1, wherein the precursor of B is selected from the group consisting of a precursor of indium, a precursor of gallium, a precursor of aluminium, and mixtures thereof.

8. The method according to claim 1, wherein the precursor of B is selected from the group consisting of the salts of B, the halides of B, the oxides of B, and the organometallic compounds of B.

9. The method according to claim 1, wherein the precursor of C is selected from the group consisting of a precursor of sulfur, a precursor of oxygen, a precursor of selenium, a precursor of tellurium and their mixtures.

10. The method according to claim 1, wherein the precursor of C is selected from the group consisting of elementary selenium dissolved in an organic solvent; elementary tellurium dissolved in an organic solvent, elementary sulfur dissolved in an organic solvent, an aliphatic thiol; a xanthate; an amine oxide; a phosphine selenide; a phosphine oxide; a compound of formula C′(Si(R₁₁)₃)₂ wherein C′ represents an element from the group consisting of S, Se and Te and each R₁₁, either identical or different, is a linear, branched or cyclic alkyl group with 1 to 10 carbon atoms.

11. The method according to claim 1, wherein preparing a mixture comprising at least one precursor of A, at least one precursor of B and at least one precursor of C at a temperature Tₐ comprises preparing the mixture in an organic solvent.

12. The method according to claim 1, wherein the prepared mixture contains an element selected from the group consisting of a stabilizer for the surface of the nanocrystals and a primary amine.

13. The method according to claim 1, wherein the temperature Tₐ is less than about 50° C., or is less than about 40° C., or is less than about 30° C.

14. The method according to claim 1, wherein the temperature T_{b} is less than about 100° C. or between about 30 and about 80° C., or between about 40 and about 60° C.

15. The method according to claim 1, wherein the temperature T_{c} is greater than about 150° C., or is greater than about 180° C., or is between about 180° C. and about 300° C., or is between about 200° C. and about 270° C.

16. The method according to claim 3, wherein the zinc precursor is selected from the group consisting of zinc salts, zinc halides, zinc oxides and zinc organometallic compounds.

17. The method according to claim 3, wherein the precursor of F is selected from the group consisting of a precursor of oxygen, a precursor of selenium, a precursor of tellurium, and mixtures thereof.

18. The method according to claim 3, adding to the mixture maintained at temperature T_{c}, at least one precursor of zinc, and at least one precursor of sulfur has a duration of between about 5 min and about 5 hrs, or between about 10 min and about 3.5 hrs, or between about 20 min and about 2 hrs.

19. A nanocrystal having a core comprising a semiconductor comprising copper, indium and sulfur, coated with a shell, the external portion of which comprises a semiconductor comprising zinc and sulfur, obtained by a method according to claim 2, characterized in that said nanocrystal has a quantum yield greater than 5% at room temperature, or greater than about 10% at room temperature, or is greater than about 20% at room temperature or is greater than about 50%.

20. The nanocrystal according to claim 19, wherein the nanostructure emits light in the spectral range from about 500 to about 900 nm.

21. A composition comprising at least one nanocrystal according to claim 19 in an aqueous medium.

22. A light-emitting diode a photovoltaic cell having the nanocrystal according to claim 19.

23. A method of using a nanocrystal according to claim 19 for fluorescent labelling of chemical or biological molecules.

24. A method of using a composition according to claim 21 for fluorescent labelling of chemical or biological molecules.

25. The method according to claim 1, further comprising purifying the nanocrystals comprising the semiconducting ternary compound.
